(19) United States
(12) Patent Application Publication
(10) Pub. No.: US 2003/0173687 A1
(43) Pub. Date: Sep. 18, 2003

(54) Dip aerator

(76) Inventor: Markus Baumann, Vlotho (DE)

Correspondence Address: Richard M. Goldberg, Suite 419, 25 East Salem Street, Hackensack, NJ, 07601, US

(21) Appl. No.: 10/387,779

(22) Filed: Mar. 13, 2003

(30) Foreign Application Priority Data
Mar. 16, 2002 (DE) 202 04 231.6

(51) Int. Cl. B01F 3/04

(52) U.S. Cl. 261/93

(57) ABSTRACT

A dip aerator for sewage treatment plants is provided with a downwardly directed pump outlet and a pump inlet, which is connected with an air hose. The pump inlet (14) is below the water level (18) in the sewage treatment basin. The air hose (20, 24) starts out from the pump inlet (14) and extends with a specified volume below the water level. In this way, it is achieved that, when the pump is started, water is delivered initially and air is emitted only later. By these means, brief repulsions without input of air become possible.

The invention relates to a dip aerator for sewage treatment plants with a downwardly directed pump outlet and an air inlet, which is connected with an air hose.

Such dip aerators have a double function in that, on the one hand, they pump air into a sewage treatment basin and, on the other, set the sewage treatment water in the basin in motion by means of a sharp, downwardly directed jet of air. This double function has the advantage that mechanical stirring equipment with stirrer blades and the like is not required. However, in certain cases, it also has disadvantages. For certain sewage treatment methods, it is desirable that the sewage treatment water is set in motion briefly from time to time without at the same time introducing air. For example, denitrification during a sewage treatment process takes place in an anaerobic phase, which exists only if there is a lack of oxygen. In these phases, it is also important to keep the water moving and to ensure uniform mixing.

It is an object of the invention to provide a dip aerator of the type named above, which makes a stirring function possible without, at the same time, introducing air into the water.

This objective is accomplished by a dip aerator of the above type owing to the fact that the air inlet is below the water level in the sewage treatment basin and that the air hose, starting out from the air inlet, extends with a specified volume below the water level.

When the dip aerator is not in operation, that part of the air hose, which is below the water level, is full of water when it passes through the dip aerator. If the dip aerator is now switched on, the water, contained in the hose, is first aspirated from the latter by the dip aerator, before air can be pumped once again. Therefore, by the selective enlargement of the volume of the hose, which is below the water level, it is possible to determine the time span between the switching on of the dip aerator and the start of the aeration function.

The delay in supplying air can be achieved by keeping a specified length of air hose under water or also by integrating an expanded chamber in the air hose. It is also possible to delay the onset of supplying air by a certain time, so that, for example, during the anaerobic sewage treatment phase, the pump can repeatedly be operated briefly in order to stir the sewage treatment water without, at the same time, introducing air into it.

In the following, preferred examples of the invention are explained in greater details by means of the attached drawing, in which

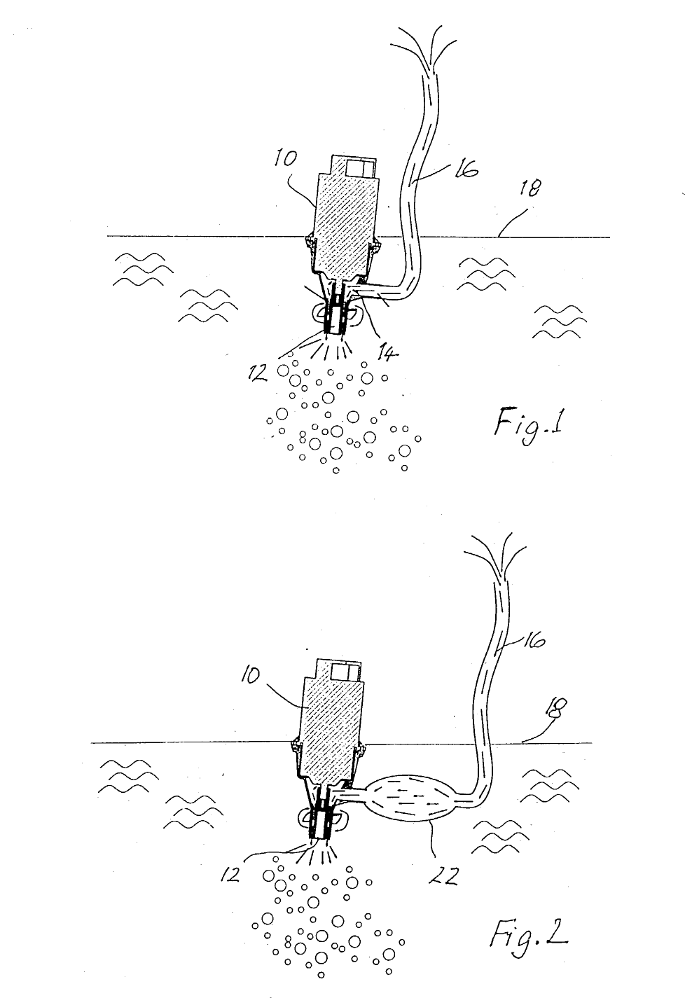

FIG. 1 shows a diagrammatic representation of a dip aerator of the usual construction,

FIG. 2 shows a corresponding representation of the dip aerator of a first embodiment of the invention and

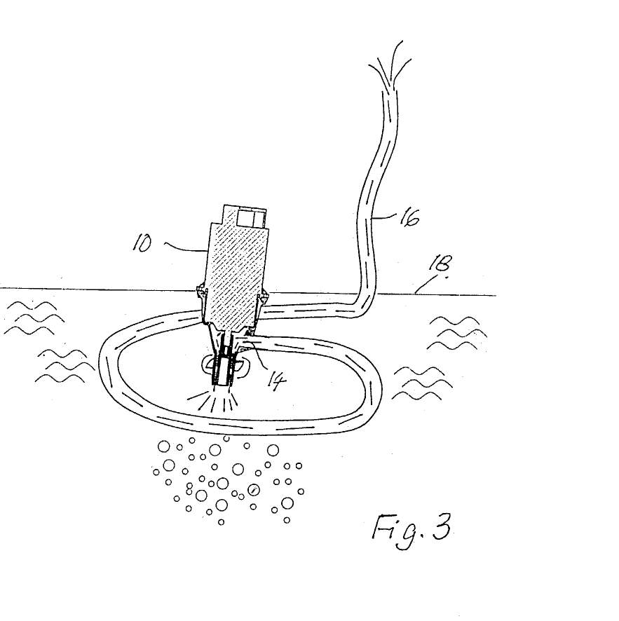

FIG. 3 relates to a second embodiment of the invention.

In FIG. 1, a dip aerator is labeled 10. It has an outlet 12 at the bottom, from which, during normal operation, a vigorous air jet is delivered downward, which forces air down to the bottom of the sewage treatment basin and, at the same time, exerts a stirring effect on the water. An air hose 16, which supplies air from a region above the water level 18, is connected with an inlet 14 of the dip aerator. When the dip aerator 10 is switched off, that part of the air hose 16, which is below the water level 18, is filled with water. However, in the case of the usual arrangement of FIG. 1, this volume of water is so small that, for example, after about 0.5 seconds, air already emerges from the outlet 12. A stirring effect without supplying air at the same time is therefore not possible practically.

FIG. 2 shows an embodiment with an air hose 20, in which an expanded chamber 22 is integrated, which is in a position below the water level 18.

This chamber accommodates a larger volume of water when the dip aerator 10 is switched off, so that, to begin with, when the dip aerator is switched on, it takes more time before air emerges once again from the outlet 12. In this way, pump surges, during which only water is emitted from the outlet 12, are possible over a longer period of time.

FIG. 3 shows an embodiment with a longer air hose 24, which is placed below the water level 18 over a greater length. The length of the air hose 24 below the water level functions as a water reservoir here, which, when the operation of the dip aerator is started, must first be pumped out before air emerges from the outlet 12. Here also, pump surges, which do not supply air, are possible. The embodiment of FIG. 3 has the advantage that the length of the section of air hose 24, which is below the water level, can easily be varied. It is, however, also possible to construct a chamber 22 with a variable capacity, perhaps in the form of a cylinder with an adjustable piston, which forms the boundary of a chamber of variable size within the cylinder. In any case, the stirring function can be carried out at least over a certain period of time, without at the same time, supplying air.

1. A dip aerator for sewage treatment plants with a downwardly directed pump outlet and a pump inlet, which is connected with an air hose, wherein the pump inlet (14) is below the water level (18) in the sewage treatment basin and the air hose (20, 24), starting out from the pump inlet (14), extends with a specified volume below the water level.

2. The dip aerator of claim 1, wherein the air hose (24), is longer than the minimum length required for connection to the pump inlet (14) below the water level (18).

3. The dip aerator of claim 1, wherein an expanded chamber (22) is integrated in the air hose (20).
